(19) United States
(12) Patent Application Publication
(10) Pub. No.: US 2026/0095468 A1
(43) Pub. Date: Apr. 2, 2026

(54) METHOD OF DETERMINING SIMILARITY BETWEEN C2 SERVERS AND DEVICE FOR PERFORMING THE SAME

(71) Applicant: OASIS SECURITY, Seongnam-si (KR)

(72) Inventors: Geun Yong KIM, Hanam-si (KR); Joon Young PAIK, Daejeon (KR); Kyung Hern NAM, Daejeon (KR)

(73) Assignee: OASIS SECURITY, Seongnam-si (KR)

(21) Appl. No.: 19/346,732

(22) Filed: Oct. 1, 2025

(30) Foreign Application Priority Data
Oct. 2, 2024 (KR) 10-2024-0133482

(51) Int. Cl. H04L 9/40

(52) U.S. Cl. CPC H04L 63/1416

(57) ABSTRACT

A method of determining similarity between command and control (C2) servers includes acquiring attribute information indicating attributes of a plurality of C2 servers, generating attribute vectors of the plurality of C2 servers by inputting at least one piece of attribute information regarding each of the plurality of C2 servers into an embedding model, storing the generated attribute vectors in a database, extracting attribute vectors for determining similarity between a first C2 server and a second C2 server from the attribute vectors stored in the database, and determining similarity between the first C2 server and the second C2 server on the basis of the extracted attribute vectors. With the method, it is possible to proactively detect and block attack attempts by identifying similar C2 servers.

### CROSS-REFERENCE TO RELATED APPLICATION

This application claims priority to and the benefit of Korean Patent Application No. 10-2024-0133482, filed on October 2, 2024, the disclosure of which is incorporated herein by reference in its entirety.

### BACKGROUND

### Field of the Invention

The present application relates to a method of determining similarity between command and control (C2) servers to identify similar C2 servers and detect and block new attack attempts, and a device for performing the method.

### Discussion of Related Art

Cyber threat intelligence (CTI) refers to a process of coping with cyber threats on the basis of processed knowledge derived from analyzing and interpreting collectable information related to cyber threats. Due to increasingly sophisticated and advanced cyber threats, the importance of defense strategies based on cyber threat intelligence is growing. In particular, advanced persistent threat (APT) attack groups that carry out sustained and sophisticated attacks against specific organizations are recognized as a major threat. APT attack groups use complex and sophisticated attack techniques to infiltrate target systems over long periods and achieve objectives such as information gathering, data theft, system damage, and the like. An important factor of these attacks is a command and control (C2) server that allows control of remote attacks. A C2 server plays a crucial role in enabling an attacker to control a victim system and transmit commands.

In addition to Korean Patent Application No. 10-2024-0017644 (a device and method for processing cyber threat information and a storage medium in which software for processing cyber threat information is stored), technologies for detecting and blocking cyber threats according to the related art rely on information about threats that have already occurred due to attacks, to detect a new threat, and thus proactive detection and blocking are not possible.

Attack groups generate new malicious code targeting various software vulnerabilities and create modified malicious code to evade detection by malicious code detection programs. Nevertheless, attack groups utilize existing C2 server infrastructures to distribute such malicious code. In addition, since attack groups tend to use similar server infrastructures, it is necessary to determine the similarity between C2 servers of attack groups in order to establish a proactive and effective defense strategy against cyber threats.

### SUMMARY OF THE INVENTION

The present invention is directed to providing a method of determining similarity between command and control (C2) servers and a device for performing the same.

Objects to be achieved by the present invention are not limited to that described above, and other objects that have not been described will be obviously appreciated by those of ordinary skill in the technical field to which the present invention pertains from the specification and accompanying drawings.

According to an aspect of the present invention, there is provided a method of determining similarity between C2 servers, the method including acquiring attribute information indicating attributes of a plurality of C2 servers, generating attribute vectors of the plurality of C2 servers by inputting at least one piece of attribute information regarding each of the plurality of C2 servers into an embedding model, storing the generated attribute vectors in a database, extracting attribute vectors for determining similarity between a first C2 server and a second C2 server from the attribute vectors stored in the database, and determining similarity between the first C2 server and the second C2 server on the basis of the extracted attribute vectors.

According to another aspect of the present invention, there is provided a device for performing a method of analyzing similarity between C2 servers, the device including a communicator configured to transmit and receive data to and from a C2 server, a storage including a memory and a database, and a processor. The processor acquires attribute information indicating attributes of a plurality of C2 servers, generates attribute vectors of the plurality of C2 servers by inputting at least one piece of attribute information regarding each of the plurality of C2 servers into an embedding model, stores the generated attribute vectors in the database, extracts attribute vectors for determining similarity between a first C2 server and a second C2 server from the attribute vectors stored in the database, and determines similarity between the first C2 server and the second C2 server on the basis of the extracted attribute vectors.

Solutions of the present invention are not limited to those described above, and other solutions that have not been described will be obviously appreciated by those of ordinary skill in the technical field to which the present invention pertains from the specification and accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic block diagram of a device according to an exemplary embodiment of the present application;

FIG. 2 is a flowchart illustrating a method of determining similarity between command and control (C2) servers according to an exemplary embodiment of the present application;

FIG. 3 is diagram illustrating a method of generating attribute vectors of a C2 server according to an exemplary embodiment of the present application;

FIG. 4 is a diagram illustrating a method of extracting attribute vectors for determining similarity between C2 servers according to an exemplary embodiment of the present application;

FIG. 5 is a flowchart illustrating a method of determining similarity between a first C2 server and a second C2 server according to an exemplary embodiment of the present application;

FIG. 6 is a diagram illustrating a method of determining similarity between a first C2 server and a second C2 server according to the exemplary embodiment of the present application;

FIG. 7 is a flowchart illustrating a method of determining similarity between a first C2 server and a second C2 server according to an exemplary embodiment of the present application;

FIG. 8 is a diagram illustrating a method of determining similarity between a first C2 server and a second C2 server according to the exemplary embodiment of the present application; and

FIG. 9 is a diagram illustrating a method of determining similarity between a first C2 server and a second C2 server according to the exemplary embodiment of the present application.

### DETAILED DESCRIPTION OF EXEMPLARY EMBODIMENTS

The above-described objects, features, and benefits of the present application will become apparent from the following detailed description associated with the accompanying drawings. However, the present application may be modified in various ways and may have several embodiments, and thus specific embodiments will be illustrated in the drawings and described in detail.

Throughout the specification, like reference numbers refer to like components. Also, components with the same functions within the same range of ideas shown in drawings of embodiments are described using the same reference numerals, and duplicate descriptions thereof will be omitted.

When the detailed description of a known function or component associated with the present application is determined to unnecessarily obscure the subject matter of the present application, the detailed description will be omitted. In addition, numbers (e.g., first, second, etc.) used in the description of the present specification are merely identifiers for distinguishing one component from others.

The suffixes “module” and “unit” used for components in the following embodiments are given or interchangeably used in consideration of only the ease of drafting the specification and do not have a meaning or role distinct from each other.

In the following embodiments, singular forms include plural forms unless the context clearly indicates otherwise.

In the following embodiments, the terms “including,” “having,” etc., mean the presence of features or components stated herein and do not preclude the possibility of adding one or more other features or components.

In the drawings, the sizes of components may be exaggerated or reduced for the convenience of description. For example, the size and thickness of each component shown in the drawings are arbitrarily shown for the convenience of description, and thus the present invention is not necessarily limited to those shown in the drawings.

When an embodiment may be implemented differently, a specific process may be performed in a different order than that described. For example, two processes described in succession may be performed substantially simultaneously or performed in a reverse order of that described.

In the following embodiments, when components, etc., are referred to as being connected, the components may be directly connected or indirectly connected with components interposed therebetween.

For example, when components, etc., are referred to as being electrically connected herein, the components, etc., may be directly and electrically connected or may be indirectly and electrically connected with a component, etc., interposed therebetween.

Meanwhile, an embedding model may be a model designed to convert text into a floating-point number array referred to as “vector,” which is designed to capture the meaning of text. In particular, in the present specification, an embedding model may represent text describing attribute information of a command and control (C2) server as a vector including a plurality of dimensions.

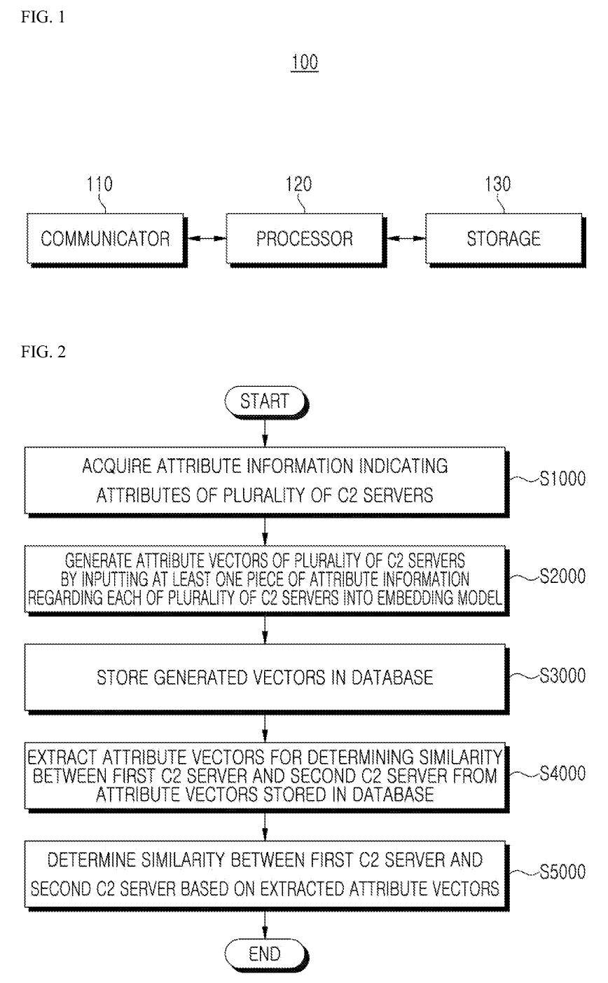

Hereinafter, a method of determining similarity between C2 servers and a device for performing the method will be described with reference to FIGS. 1 to 9.

FIG. 1 is a schematic block diagram of a device according to an exemplary embodiment of the present application. Referring to FIG. 1, a device 100 may include a communicator 110, a processor 120, and a storage 130.

The communicator 110 may support establishment of a direct (wired) communication channel or a wireless communication channel between the device 100 and an external device (e.g., a server) and communication via the established communication channel. The communicator 110 may operate independently of the processor 120 (e.g., an application processor) and may include at least one communication processor that supports direct (e.g., wired) communication or wireless communication. According to the exemplary embodiment, the communicator 110 may include a wireless communication module (e.g., a cellular communication module, a short-range communication module, or a global navigation satellite system (GNSS) communication module) or a wired communication module (e.g., a local area network (LAN) communication module or a power line communication module).

The communicator 110 may transmit and receive data to and from a plurality of C2 servers.

The processor 120 may execute software to control at least one other component (e.g., a hardware or software component) of the device 100 connected to the processor 120 and perform various kinds of data processing or computation. According to the exemplary embodiment, as at least a part of data processing or computation, the processor 120 may store a command or data received from another component (e.g., the communicator 110) in a volatile memory, process the command or data stored in the volatile memory, and store result data in a non-volatile memory. According to the exemplary embodiment, the processor 120 may include a main processor (e.g., a central processing unit (CPU) or an application processor) and an auxiliary processor (e.g., a neural processing unit (NPU)) that may operate independently of or together with the main processor. For example, when the device 100 includes the main processor and the auxiliary processor, the auxiliary processor may use lower power than the main processor or may be configured to be specialized in a designated function. The auxiliary processor may be implemented separately from the main processor or as a part of the main processor.

According to the exemplary embodiment, the auxiliary processor (e.g., the NPU) may include a hardware structure specialized in processing an artificial intelligence (AI) model. The AI model may be generated through machine learning. This learning may be performed by, for example, the device 100 itself in which the AI model is executed, or a server. A learning algorithm may include, for example, supervised learning, unsupervised learning, semi-supervised learning, or reinforcement learning, but is not limited to the foregoing examples. The AI model may include a plurality of artificial neural network layers. An artificial neural network may be, but is not limited to, one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof. In addition to or in place of a hardware structure, the AI model may include a software structure.

The processor 120 may acquire attribute information indicating attributes of the plurality of C2 servers. Specifically, the processor 120 may transmit a request message to the plurality of C2 servers through the communicator 110 and receive response messages corresponding to the request message. Then, the processor 120 may acquire attribute information of the C2 servers included in the received response messages. Alternatively, the processor 120 may receive the attribute information of the plurality of C2 servers from an external device through the communicator 110. Here, the attribute information may be text indicating at least one of domain names of the C2 servers, domain registrars, and information that is related to the C2 servers and included in response messages received from the C2 servers.

The processor 120 may generate attribute vectors of the plurality of C2 servers by inputting at least one piece of attribute information regarding each of the plurality of C2 servers into an embedding model. Specifically, the processor 120 may generate a first attribute vector by inputting first attribute information of a first C2 server into a first embedding model. Also, the processor 120 may generate a second attribute vector by inputting second attribute information of the first C2 server into a second embedding model. The processor 120 may perform a task of generating an attribute vector by applying each of N pieces of attribute information of the first C2 server to an embedding model. Although the first embedding model and the second embedding model may be the same model or different models, attribute vectors generated by the first embedding model and the second embedding model may be vectors with the same dimensions. Also, the processor 120 may perform the same task for attribute information of each of a second C2 server, …, and an N^{th} C2 server.

The processor 120 may generate attribute type vectors by inputting attribute type information indicating types of attributes into an embedding model.

The processor 120 may store the generated attribute vectors in a database. Specifically, the processor 120 may store C2 server information, attribute information of the corresponding C2 servers, and the attribute vectors of the corresponding C2 servers in the database together. In addition, the processor 120 may store the attribute type vectors in the database.

The processor 120 may extract all or some attribute vectors of the first C2 server and the second C2 server between which similarity will be determined from the attribute vectors stored in the database. Then, the processor 120 may generate an attribute vector sequence on the basis of a plurality of extracted attribute vectors. For example, the processor 120 may generate an attribute vector sequence of the first C2 server using the extracted attribute information of the first C2 server and generate an attribute vector sequence of the second C2 server using the extracted attribute information of the second C2 server.

The processor 120 may determine similarity between the first C2 server and the second C2 server on the basis of the attribute vectors extracted from the database. According to the exemplary embodiment, the processor 120 may determine a similarity between attribute vectors of the first C2 server and the second C2 server regarding each attribute and determine similarity between the first C2 server and the second C2 server on the basis of the similarities. According to another exemplary embodiment, the processor 120 may determine the similarity using not only attribute vectors but also attribute type vectors associated with the types of attributes.

The storage 130 may store various kinds of data used by at least one component (e.g., the processor 120) of the device 100. The data may include, for example, software and input or output data for a command related to the software. The storage 130 may include a volatile memory or a non-volatile memory.

The storage 130 may include a database for storing attribute vectors related to attribute information of C2 servers. In addition, the database may store attribute type vectors associated with the types of attribute information.

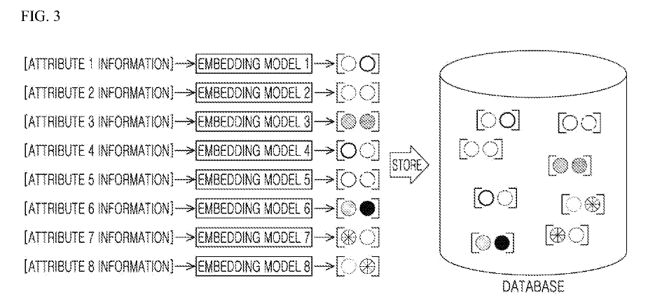

FIG. 2 is a flowchart illustrating a method of determining similarity between C2 servers according to an exemplary embodiment of the present application. There is no limitation on the order of operations in FIG. 2, and another operation may be additionally performed between two adjacent operations. Further, at least some of the operations of FIG. 2 may be omitted. In the present invention, the electronic device 100 referred to as performing a specific operation may represent that the processor 120 of the electronic device 100 performs the specific operation or controls other hardware such that the other hardware performs the specific operation.

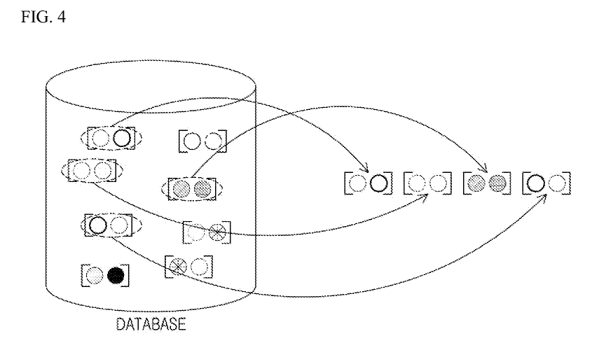

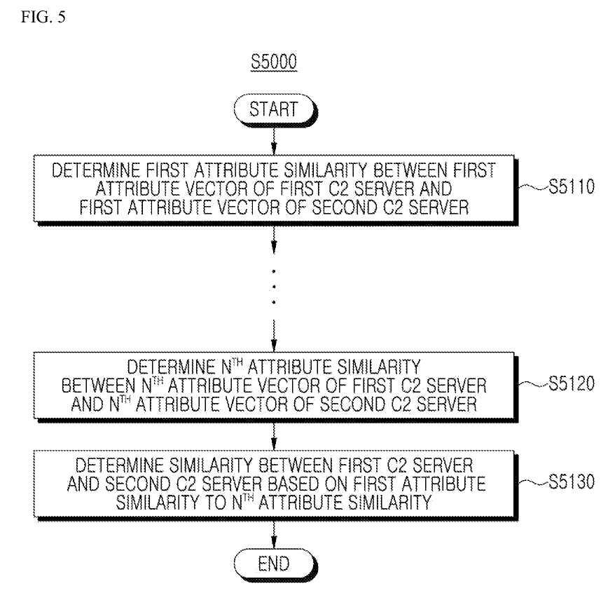

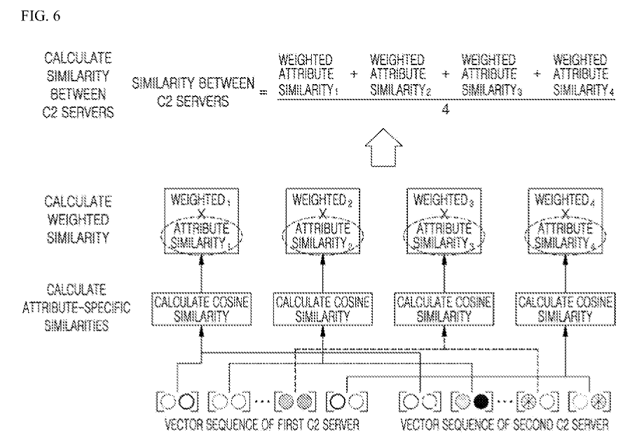

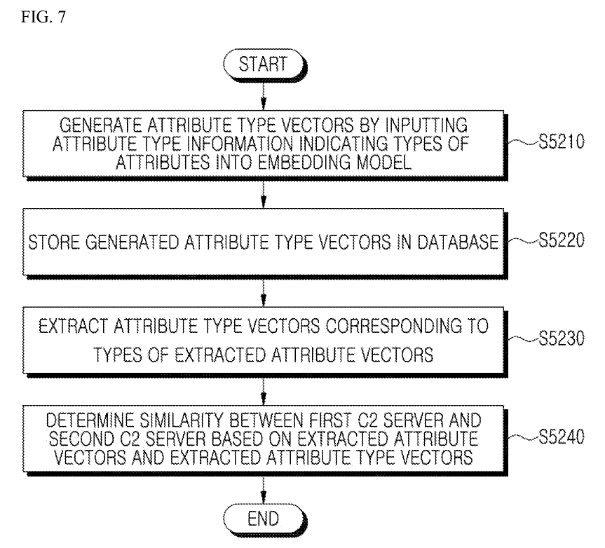

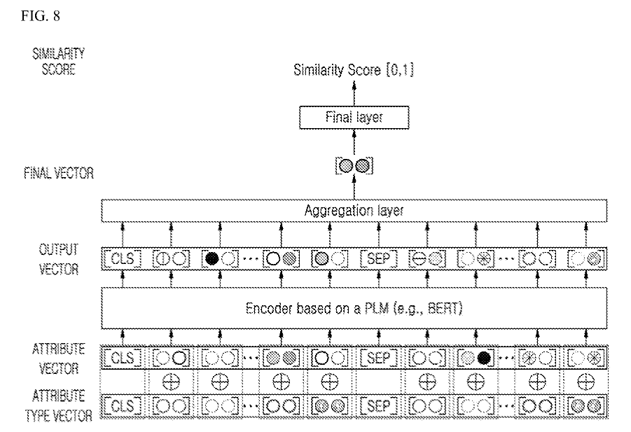

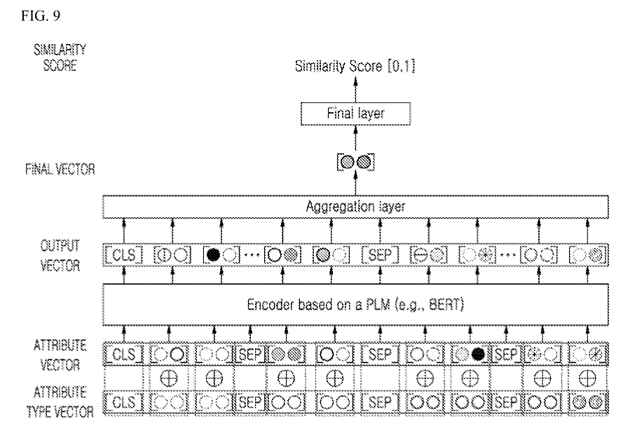

FIG. 2 will be described in further detail with reference to FIGS. 3 to 9. FIG. 3 is diagram illustrating a method of generating attribute vectors of a C2 server according to an exemplary embodiment of the present application. FIG. 4 is a diagram illustrating a method of extracting attribute vectors for determining similarity between C2 servers according to an exemplary embodiment of the present application. FIG. 5 is a flowchart illustrating a method of determining similarity between a first C2 server and a second C2 server according to an exemplary embodiment of the present application. FIG. 6 is a diagram illustrating a method of determining similarity between a first C2 server and a second C2 server according to the exemplary embodiment of the present application. FIG. 7 is a flowchart illustrating a method of determining similarity between a first C2 server and a second C2 server according to an exemplary embodiment of the present application. FIG. 8 is a diagram illustrating a method of determining similarity between a first C2 server and a second C2 server according to the exemplary embodiment of the present application. FIG. 9 is a diagram illustrating a method of determining similarity between a first C2 server and a second C2 server according to the exemplary embodiment of the present application.

Referring to FIG. 2, the device 100 may acquire attribute information indicating attributes of a plurality of C2 servers (S1000). The attribute information of the C2 servers is information on the C2 servers that is collectable from a network. For example, the attribute information of the C2 servers may be text indicating at least one of domain names of the C2 servers, domain registrars, and information that is related to the C2 servers and included in response messages received from the C2 servers.

According to the exemplary embodiment, the device 100 may acquire the attribute information of the C2 servers through passive scanning and active scanning. According to passive scanning, the device 100 may acquire information on a plurality of C2 servers from a public scanning service. According to active scanning, the device 100 may transmit a request message to a plurality of C2 servers, receive response messages in response to the request message, and then directly acquire server information included in the received response messages. The device 100 may acquire the attribute information of the C2 servers using both passive scanning and active scanning or only one thereof.

The device 100 may generate attribute vectors of the plurality of C2 servers by inputting at least one piece of attribute information regarding each of the plurality of C2 servers into an embedding model (S2000). Specifically, a case where attribute information of a first C2 server is eight pieces of text information will be described as an example with reference to FIG. 3, but there is no limitation on the number of pieces of attribute information. The device 100 may generate a first attribute vector by inputting first attribute information into a first embedding model, generate a second attribute vector by inputting second attribute information into a second embedding model, …, and generate an eighth attribute vector by inputting eighth attribute information into an eighth embedding model. The device 100 may use one or more embedding models to generate attribute vectors of attribute information. In other words, some or all of the first embedding model to the eighth embedding model may be the same model or different models. However, the first embedding model to the eighth embedding model may be models that generate vectors with the same dimensions as shown in FIG. 3.

The device 100 may store the generated vectors in the database (S3000). Specifically, the device 100 may store C2 server information, attribute information of the corresponding C2 servers, and the attribute vectors of the corresponding C2 servers in the database together.

The device 100 may extract attribute vectors for determining similarity between the first C2 server and a second C2 server from the attribute vectors stored in the database (S4000). Specifically, the device 100 may extract all or some attribute vectors of the first C2 server and the second C2 server between which similarity will be determined from the attribute vectors stored in the database. Meanwhile, the device 100 may receive a user input for searching for attribute vectors and extract attribute vectors in accordance with the user input.

For example, as shown in FIG. 4, the device 100 may extract the first attribute vector to the fourth attribute vector from the first attribute vector to the eighth attribute vector of the first C2 server. Then, the processor 120 may generate a vector sequence composed of the first attribute vector to the fourth attribute vector.

The device 100 may determine similarity between the first C2 server and the second C2 server on the basis of the extracted attribute vectors (S5000).

According to the exemplary embodiment, the device 100 may determine a similarity between attribute vectors of the first C2 server and the second C2 server regarding each attribute and determine similarity between the first C2 server and the second C2 server on the basis of the similarities. The corresponding embodiment will be described in further detail with reference to FIGS. 5 and 6.

Referring to FIG. 5, the device 100 may determine a first attribute similarity that is a similarity between a first attribute vector of the first C2 server and a first attribute vector of the second C2 server (S5110). The device 100 may repeat such a process N times to determine an N^{th} attribute similarity that is a similarity between an N^{th} attribute vector of the first C2 server and an N^{th} attribute vector of the second C2 server (S5120). Then, the device 100 may determine similarity between the first C2 server and the second C2 server on the basis of the first attribute similarity to the N^{th} attribute similarity (S5130). For example, as shown in FIG. 6, the device 100 may calculate a cosine similarity between two attribute vectors of the first C2 server and the second C2 server regarding each attribute to calculate attribute similarities. The device 100 may calculate a first attribute similarity to a fourth attribute similarity and multiply each attribute similarity by a weight predefined for the corresponding attribute to calculate a weighted attribute similarity. Then, the device 100 may calculate an average of weighted attribute similarities to determine similarity between the first C2 server and the second C2 server.

Referring back to operation S5000 of FIG. 2, another embodiment in which the device 100 determines similarity between C2 servers will be described below. According to the other embodiment, the device 100 may determine similarity between a first C2 server and a second C2 server on the basis of not only attribute vectors but also attribute type vectors associated with the types of attributes. The corresponding embodiment will be described in further detail with reference to FIGS. 7 to 9.

Referring to FIG. 7, the device 100 may generate attribute type vectors by applying attribute type information indicating the types of attributes to an embedding model (S5210). Specifically, the device 100 may input attribute type information into an embedding model to generate attribute type vectors that are factors for identifying which attribute information each attribute vector has. For example, the text “AA” may be a domain, and the same text “AA” may also be a domain registrar. Accordingly, a factor is required for identifying which type of attribute information corresponding attribute information is. Therefore, it is possible to improve accuracy in determining similarity between C2 servers using attribute type vectors.

The device 100 may store the generated attribute type vectors in the database (S5220). Specifically, the device 100 may store the attribute type vectors of corresponding C2 servers in the database together with C2 server information, attribute information of the corresponding C2 servers, and the attribute vectors of the corresponding C2 servers.

The device 100 may extract attribute type vectors corresponding to the types of extracted attribute vectors (S5230). Specifically, the device 100 may extract attribute vectors for determining similarity between the first C2 server and the second C2 server from the attribute vectors stored in the database and extract attribute type vectors corresponding to each of the extracted attribute vectors. For example, when an attribute vector corresponding to a domain of the first C2 server and an attribute vector corresponding to a domain of the second C2 server are extracted, the device 100 may extract attribute type vectors indicating that the attribute vectors represent information on the domains.

The device 100 may determine similarity between the first C2 server and the second C2 server on the basis of the extracted attribute vectors and the extracted attribute type vectors (S5240). For example, the device 100 may determine similarity between the first C2 server and the second C2 server by inputting the attribute vectors and the attribute type vectors into a model (e.g., a pretrained language model (PLM)) for measuring similarity between sentences. Specifically, as shown in FIGS. 8 and 9, the device 100 may determine similarity between the first C2 server and the second C2 server by inputting values acquired by adding the attribute type vectors to an attribute vector sequence of the first C2 server and an attribute vector sequence of the second C2 server into a cross-encoder structure which is a model for measuring similarity between sentences. Here, the device 100 may add the attribute type vectors to the attribute vector sequences and input the results into an encoder (e.g., an encoder based on a PLM (e.g., a bidirectional encoder representations from transformers (BERT))), and the attribute type vectors may be added to the attribute vector sequences in various ways.

An exemplary embodiment of adding attribute type vectors to attribute vector sequences will be described with reference to FIG. 8. The device 100 may distinguish between the attribute vector sequence of the first C2 server and the attribute vector sequence of the second C2 server using an [SEP] token. Also, the device 100 may add attribute type vectors to each of corresponding attribute vectors and then input the results into the encoder. Result vectors of the encoder may be output through an aggregation layer as a final vector indicating similarity between the C2 servers. Here, the aggregation layer may employ various aggregation techniques (e.g., max-pooling, mean-pooling, classification (CLS) token, etc.). The final vector may be input into a final layer and output as a similarity value of 0 to 1. A similarity value closer to 1 indicates higher similarity. Here, the final layer may be composed of a single linear layer or nested linear layers.

Another exemplary embodiment of adding attribute type vectors to attribute vector sequences will be described with reference to FIG. 9. The device 100 may categorize the attribute vectors by type using [SEP] tokens and arrange the attribute vectors such that attribute vectors of the same attribute may be consecutively positioned. Specifically, as shown in FIG. 9, an attribute vector of a first attribute of the first C2 server and an attribute vector of a first attribute of the second C2 server may be consecutively positioned, an attribute vector of a second attribute of the first C2 server and an attribute vector of a second attribute of the second C2 server may be consecutively positioned, and the attribute vectors of the first attribute and those of the second attribute may be categorized using an [SEP] token. Attribute type vectors categorized using an [SEP] token may be the same attribute type. For example, an attribute type vector indicating the first attribute of the first C2 server is the same as an attribute type vector indicating the first attribute of the second C2 server. Subsequently, the device 100 may add attribute type vectors corresponding to each of the attribute vectors and input the result into an encoder. A process after the result is input into the encoder is the same as that of FIG. 8, and thus description thereof will be omitted.

Meanwhile, according to an exemplary embodiment of the present invention, attribute vectors and attribute type vectors may be generated in advance and stored in the database, and the stored vectors may be extracted and input into the cross-encoder. In other words, since the attribute vectors and attribute type vectors are stored in the database in advance and the previously stored vectors are extracted and input into the cross-encoder, it is unnecessary to convert text into a vector at the cross-encoder. In the case of inputting text into the cross-encoder, it is necessary to perform a vectorization task every time in order to determine similarity for even the same text. However, according to the exemplary embodiment of the present invention, an operation of converting the text into a vector and storing the vector is performed in advance, and thus the vectorization task is not performed again on the same information.

As described above, the device 100 can determine similarity between C2 servers using attribute vectors indicating attribute information of C2 servers and attribute type vectors indicating to which attributes the attribute vectors correspond.

With the method of determining similarity between C2 servers and the electronic device for performing the method according to the exemplary embodiments of the present invention, it is possible to proactively detect and block cyber threats by identifying similar C2 servers on the basis of attribute vectors related to attributes of C2 servers.

Since similarity between C2 servers is determined on the basis of attribute vectors related to attributes of C2 servers according to the method of determining similarity between C2 servers and the electronic device for performing the method according to the exemplary embodiments of the present invention, even when an attack group modifies some attribute information to continue an attack, it is possible to determine that there is high similarity. For example, when a domain address is changed from secureupdate.com to update-sec.com, the two domains are not determined as similar domains according to methods such as keyword comparison. However, when the domain addresses are converted into vectors and compared with each other, the two domains can be determined as highly similar domains. Therefore, in the case of determining similarity between C2 servers on the basis of attribute vectors according to an exemplary embodiment of the present invention, it is advantageously possible to detect highly similar servers that are undetectable through keyword comparison or the like.

According to an exemplary embodiment of the present invention, it is possible to proactively detect and block new attack attempts by identifying similar C2 servers.

The features, structures, effects, etc., described in the exemplary embodiments are included in at least one embodiment of the present invention and are not necessarily limited to one embodiment. Further, the features, structures, effects, etc., described in each embodiment can be combined or modified in other embodiments by those of ordinary skill in the art to which the embodiments belong. Accordingly, the combinations and modifications should be construed as falling within the scope of the present invention.

Although embodiments of the present invention have been described above, these are merely examples and do not limit the present invention. The present invention can be modified and applied in various ways not illustrated above without departing from the features of the present invention by those of ordinary skill in the art. In other words, each component described in detail in the embodiments can be modified. Also, differences related to the modification and application should be construed as falling within the scope of the present invention, which is defined by the following claims.

What is claimed is:

1. A method of determining similarity between command and control (C2) servers, the method comprising:
acquiring attribute information indicating attributes of a plurality of C2 servers;
generating attribute vectors of the plurality of C2 servers by inputting at least one piece of attribute information regarding each of the plurality of C2 servers into an embedding model;
storing the generated attribute vectors in a database;
extracting attribute vectors for determining similarity between a first C2 server and a second C2 server from the attribute vectors stored in the database; and
determining similarity between the first C2 server and the second C2 server on the basis of the extracted attribute vectors.

2. The method of claim 1, wherein the determining of the similarity between the first C2 server and the second C2 server on the basis of the extracted attribute vectors comprises:
determining a first attribute similarity between a first attribute vector of the first C2 server and a first attribute vector of the second C2 server;
determining an n^{th} attribute similarity between an n^{th} attribute vector of the first C2 server and an n^{th} attribute vector of the second C2 server; and
determining the similarity between the first C2 server and the second C2 server on the basis of the first attribute similarity to the n^{th} attribute similarity.

3. The method of claim 1, further comprising:
generating attribute type vectors by inputting attribute type information indicating types of the attributes into an embedding model; and
storing the generate attribute type vectors in the database.

4. The method of claim 3, wherein the determining of the similarity between the first C2 server and the second C2 server on the basis of the extracted attribute vectors comprises:
extracting attribute type vectors corresponding to types of the extracted attribute vectors; and
determining the similarity between the first C2 server and the second C2 server on the basis of the extracted attribute vectors and the extracted attribute type vectors.

5. The method of claim 1, wherein the extracting of the attribute vectors for determining the similarity between the first C2 server and the second C2 server from the attribute vectors stored in the database comprises:
generating an attribute vector sequence of the first C2 server composed of a plurality of extracted attribute vectors of the first C2 server; and
generating an attribute vector sequence of the second C2 server composed of a plurality of extracted attribute vectors of the second C2 server.

6. The method of claim 1, wherein the acquiring of the attribute information of the plurality of C2 servers comprises:
transmitting a request message to the C2 servers and receiving response messages corresponding to the request message; and
acquiring attribute information of the C2 servers included in the received response messages.

7. The method of claim 1, wherein the attribute information is text indicating at least one of domain names of the C2 servers, domain registrars, and information that is related to the C2 servers and included in response messages received from the C2 servers.

8. The method of claim 1, wherein the generating of attribute vectors of the plurality of C2 servers by inputting the at least one piece of the attribute information regarding each of the plurality of C2 servers into the embedding model comprises:
generating a first attribute vector by inputting first attribute information of the first C2 server into a first embedding model; and
generating a second attribute vector by inputting second attribute information of the first C2 server into a second embedding model.

9. The method of claim 8, wherein the first attribute vector and the second attribute vector have the same dimensions.

10. A computer-readable recording medium on which a program causing a computer to perform the method of claim 1 is recorded.

11. A device for performing a method of analyzing similarity between command and control (C2) servers, the device comprising:
a communicator configured to transmit and receive data to and from a C2 server;
a storage including a memory and a database; and
a processor,
wherein the processor acquires attribute information indicating attributes of a plurality of C2 servers, generates attribute vectors of the plurality of C2 servers by inputting at least one piece of attribute information regarding each of the plurality of C2 servers into an embedding model, stores the generated attribute vectors in the database, extracts attribute vectors for determining similarity between a first C2 server and a second C2 server from the attribute vectors stored in the database, and determines similarity between the first C2 server and the second C2 server on the basis of the extracted attribute vectors.
